(19) United States
(12) Patent Application Publication
(10) Pub. No.: US 2025/0155620 A1
(43) Pub. Date: May 15, 2025

(54) OPTICAL COATINGS AND OPTICAL ELEMENTS

(71) Applicant: CORNING INCORPORATED, CORNING, NY (US)

(72) Inventors: Nicholas Levi Bredberg, Jaffrey, NH (US); Yongli Xu, Keene, NH (US)

(21) Appl. No.: 18/931,930

(22) Filed: Oct. 30, 2024

Related U.S. Application Data
(60) Provisional application No. 63/598,264, filed on Nov. 13, 2023.

(51) Int. Cl. G02B 5/20; G02B 1/10; G02B 5/26

(52) U.S. Cl. CPC G02B 5/208; G02B 1/10; G02B 5/26

(57) ABSTRACT

Optical elements, optical coatings, and methods of making the same are described herein. In some embodiments, an optical element may include a substrate and a coating. The coating may include a first major surface and a second major surface opposite the first major surface, and the first major surface of the coating may be in direct contact with the substrate. The coating may further include a layer of zinc chalcogenide atop the substrate and a layer of Au atop the layer of zinc chalcogenide. In some embodiments, the coating may further include another layer of zinc chalcogenide atop the layer of Au.

### CROSS REFERENCE TO RELATED APPLICATION

This application claims the benefit of priority under 35 U.S.C. § 119 of U.S. Provisional Application Ser. No. 63/598,264 filed on Nov. 13, 2023, the content of which is relied upon and incorporated herein by reference in its entirety.

### FIELD

The present disclosure generally relates to optical coatings and optical elements with high reflectance in the infrared and to methods of making the same.

### BACKGROUND

Infrared (IR) and thermal imaging systems have witnessed increased uses in many applications. Advancements in technologies have miniaturized IR and thermal imaging sensors, making them highly portable, increasing their ease of use, saving repair times and costs, etc. There is always a need for technological breakthroughs that facilitate advancement of new IR and thermal imaging systems that can meet the ever-increasing demand for more efficient manufacturing, improved device performance, etc.

### SUMMARY

Described herein are high index coatings and optical elements incorporating the high index coatings. The coatings may include one or more adhesion layers of zinc chalcogenide for forming strong bonding between a gold layer and its neighboring layers. The one or more adhesion layers of zinc chalcogenide may also be used to improve bonding of the coating stack to the substrate to prevent delamination. The zinc chalcogenide adhesion layers described herein simplify device design and manufacturing and improve device optical performance. Further, optical elements having the zinc chalcogenide adhesion layers applied to the gold interface and/or to the substrate interface demonstrate superior environmental and mechanical durability within wide temperature ranges.

In some embodiments, an optical element may include a substrate and a coating. The coating may include a first major surface and a second major surface opposite the first major surface. The first major surface of the coating may be in direct contact with the substrate. The coating may further include a layer of zinc chalcogenide atop the substrate and a layer of Au atop the layer of zinc chalcogenide.

In some embodiments, an optical coating may include a first layer of zinc chalcogenide, a layer of Au atop the first layer of zinc chalcogenide, and a second layer of zinc chalcogenide atop the layer of Au. The coating may have an average reflectance of greater than or equal to 98%, or greater than or equal to 99%, for all wavelengths from 7.5 μm to 13.5 μm incident on a major surface of the coating at an angle of incidence that is greater than or equal to 5° and less than or equal to 55°.

In some embodiments, a method of making an optical element may include forming a coating on a substrate. Forming the coating may include forming a layer of zinc chalcogenide atop the substrate and forming a layer of Au atop the layer of zinc chalcogenide. The coating may include a first major surface and a second major surface opposite the first major surface. The first major surface of the coating may be in direct contact with the substrate.

In some embodiments, a method of making an optical coating may include forming a first layer of zinc chalcogenide, forming a layer of Au atop the first layer of zinc chalcogenide, and forming a second layer of zinc chalcogenide atop the layer of Au. The coating may have an average reflectance of greater than or equal to 98%, or greater than or equal to 99%, for all wavelengths from 7.5 μm to 13.5 μm incident on a major surface of the coating at an angle of incidence that is greater than or equal to 5° and less than or equal to 55°.

These and other aspects, objects, and features of the present disclosure will be understood and appreciated by those skilled in the art upon studying the following specification, claims, and appended drawings.

### BRIEF DESCRIPTION OF THE DRAWINGS

FIG. 1 shows reflectance of aluminum, silver, and gold mirrors.

FIG. 2 schematically illustrates a layer stack having a gold layer and metal adhesion layers.

FIGS. 3A-3D schematically illustrates various optical elements according to some embodiments.

FIGS. 4A and 4B show theoretical prediction results of surface reflectance (R %) for gold layers with and without adhesion layers.

FIG. 5 schematically illustrates another optical element according to some embodiments.

FIG. 6 schematically illustrates another optical element according to some embodiments.

FIG. 7 shows simulated reflectance of a first exemplary optical element according to some embodiments.

FIG. 8 shows measured outer reflectance of the first exemplary optical element.

FIG. 9 shows measured outer reflectance of second, third, and fourth exemplary optical elements according to some embodiments.

FIG. 10 shows measured outer reflectance of the third exemplary optical element before and after the humidity test.

FIG. 11 shows simulated internal reflectance of a fifth exemplary optical element according to some embodiments.

FIG. 12 shows simulated air side reflectance of the fifth exemplary optical element.

FIG. 13 shows measured air side reflectance of the fifth exemplary optical element.

### DETAILED DESCRIPTION

In the following detailed description, for purposes of explanation and not limitation, example embodiments disclosing specific details are set forth to provide a thorough understanding of various principles of the present disclosure. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is not intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is not intended that an order be required. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

In this disclosure, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In this specification and in the claims that follow, reference will be made to a number of terms which shall be defined to have the following meanings.

“Include,” “includes,” or like terms means encompassing but not limited to, that is, inclusive and not exclusive.

The indefinite article “a” or “an” and its corresponding definite article “the” as used herein means at least one, or one or more, unless specified otherwise.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” means one or more of comprises, consists essentially of, or consists of. For example, a component that is formed from a particular material can comprise the particular material, consist essentially of the particular material, or consist of the particular material.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined or coupled to each other through one or more intervening elements. Elements in contact may be rigidly or non-rigidly joined. Contacting refers to placing two elements in direct or indirect contact. Elements in direct (indirect) contact may be said to directly (indirectly) contact each other.

The terms “atop,” “on,” “disposed atop,” or “disposed on” refers to direct or indirect contact. If one layer is referred to herein as being atop, on, disposed atop, or disposed on another layer, the two layers are in direct or indirect contact. The terms “directly atop,” “directly on,” or “directly disposed atop,” or “directly disposed on” means that the two layers are in direct contact.

The term “index” refers to refractive index and is given the symbol “n”, where refractive index means the refractive index at a wavelength of 10.0 microns. Refractive index as used herein refers to the real part of the complex refractive index. The imaginary part of the complex refractive index is referred to herein as the “extinction coefficient” and is given the symbol “k”.

The term “layer” refers to a region of a material that is compositionally homogeneous and is intended to encompass the entirety of the dimensions of a compositionally homogeneous region of material and not constituent portions thereof.

The term “high index layer” refers to a layer having a refractive index greater than or equal to 1.8 in the wavelengths ranging from 0.5 μm to 13.5 μm or from 0.5 μm to 15 μm.

The term “low index layer” refers to a layer having a refractive index less than 1.8 in the wavelengths ranging from 0.5 μm to 13.5 μm or from 0.5 μm to 15 μm.

The term “LWIR” means “long wavelength infrared” and refers to the region of the electromagnetic spectrum in the wavelength range from 7.5 microns to 13.5 microns.

Optical coatings have applications over a broad range of wavelengths, such as from ultraviolet (UV) to far infrared (FIR), including widely used spectra of visible light, near-infrared light (NIR), short-wave infrared (SWIR), mid-infrared (MIR), and long wavelength infrared (LWIR). One primary function of optical coatings may include controlling the behavior of light as it passes through or reflects off of an optical surface. The coating materials may be selected to produce specific optical properties, such as wavelength selectivity, polarization, antireflection. etc. The thickness and composition of the coating layers may be precisely controlled to achieve desired optical properties.

Optical coatings may include two broad categories: dielectric coatings and metallic coatings. Dielectric coatings use thin layers of transparent materials, such as oxides, nitrides, or fluorides, to modify the optical properties of a surface. Metallic coatings, such as metallic mirror coatings, use thin layers of metals, such as aluminum, silver, or gold, to control the reflectivity or opacity of the surface. To ensure high performance and environmental durability of the optical coatings, one or more adhesion layers in the dielectric coatings and/or the metallic coatings may be applied.

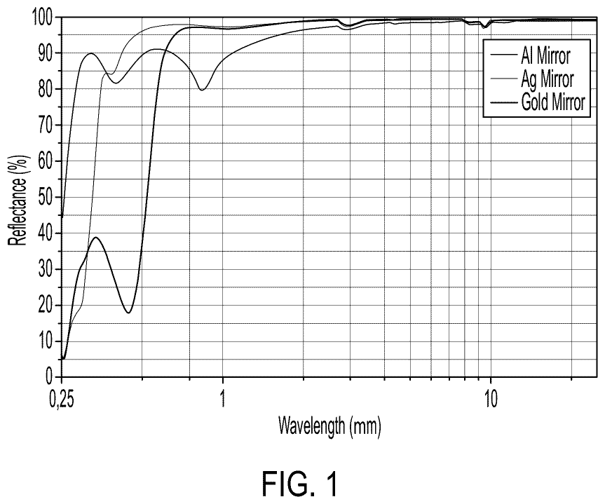

Aluminum, silver, and gold are common metal mirrors and/or reflectors used in metallic coatings. As shown in FIG. 1, for wavelengths greater than or equal to 600 nm, gold may be preferred for its optical performance. The excellent reflectivity in the visible and IR spectral regions allows gold mirrors to be used in optical applications where high reflectivity and low absorption are required. Another important aspect of the performance of a metallic mirror is its durability and resistance to environmental factors, such as humidity and temperature. Gold is a very stable material and is resistant to oxidation and corrosion, which can affect the reflectivity of a mirror over time. Due to its resistance to corrosion and oxidation compared to aluminum and silver, gold is a popular choice for use in harsh or humid environments. However, mechanical durability of gold can be limited due to its soft nature and loose bonding to neighboring layers in a coating stack. As a result, a gold mirror can be prone to scratching, peeling, and/or other damages, which can affect the reflectivity of the mirror.

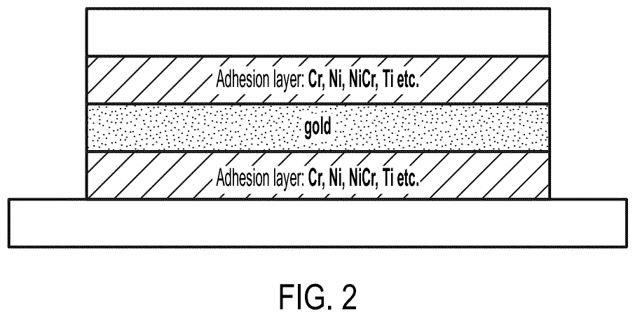

To improve the durability of gold mirrors, a gold layer typically needs to be buried in a coating stack, and one or more adhesion layers are introduced to bond the gold layer to its neighboring layers without negatively affecting the optical performance of the gold mirror. A conventional layer stack having a gold layer is shown in FIG. 2. Depending on the substrate material and the specific requirements of the application, typical materials used for an adhesion layer may include chromium, titanium, nickel, or their alloys to provide bonding to the substrate and other neighboring layers. However, none of these materials is optical friendly to LWIR optics. Due to the absorption and poor reflectivity of these metal/alloy adhesion layers (even applied at very low thicknesses), the optical performance of the resultant gold mirror is negatively impacted. Further, materials such as chromium, titanium, and nickel have high melting points, which can make thermal evaporation difficult to apply.

The inventors have discovered that by using an adhesion layer of high index coating materials, such as zinc chalcogenide, strong bonding can be formed between a gold layer and its neighboring layers without negatively affecting the optical performance of the gold mirror. Additionally, when applied to the substrate, the adhesion layer of zinc chalcogenide may also improve the bonding of the optical stack to the substrate to prevent delamination which may otherwise occur over time due to thermal and/or mechanical stresses, humidity, and/or other environmental factors. As will be discussed in more detail below, optical elements having one or more adhesion layers of zinc chalcogenide applied to the gold interfaces and/or to the substrate interface demonstrate superior environmental and mechanical durability within wide temperature ranges. Further, when compared to conventional chromium, nickel, titanium adhesion layers, the zinc chalcogenide adhesion layers described herein provide superior optical performance while simplifying the optical design and manufacturing. For example, the inventors have found that in some embodiments, a gold layer with a zinc chalcogenide adhesion layer may have greater reflectance than a pure gold layer without any adhesion layer as will be discussed in more detail below. Gold mirrors with one or more zinc chalcogenide adhesion layers can be used in either outer surface or internal surface reflection applications.

Reference will now be made in detail to illustrative embodiments of the present description.

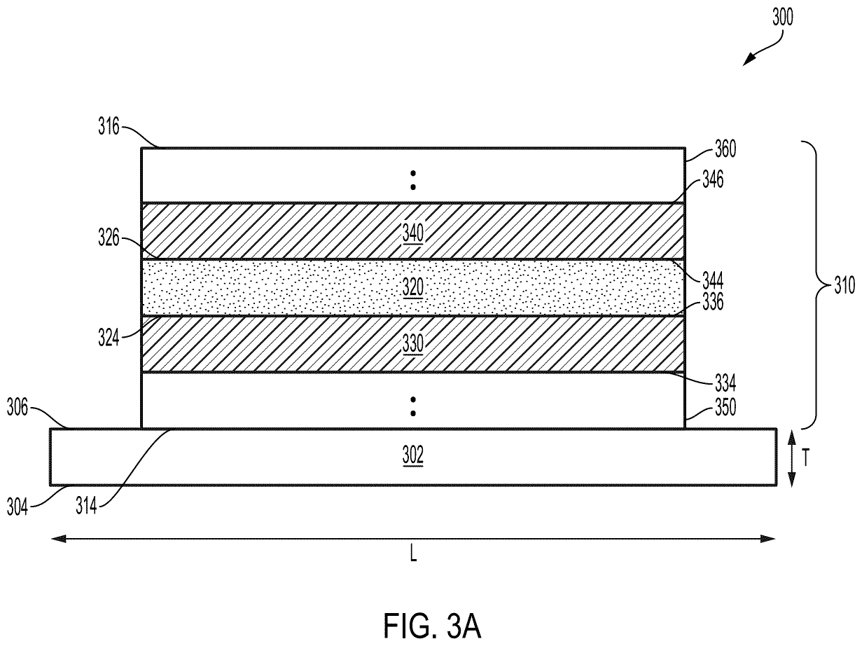

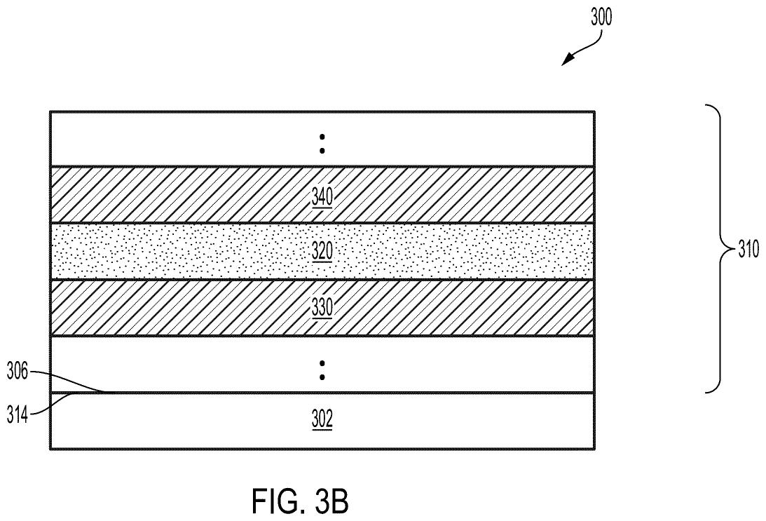

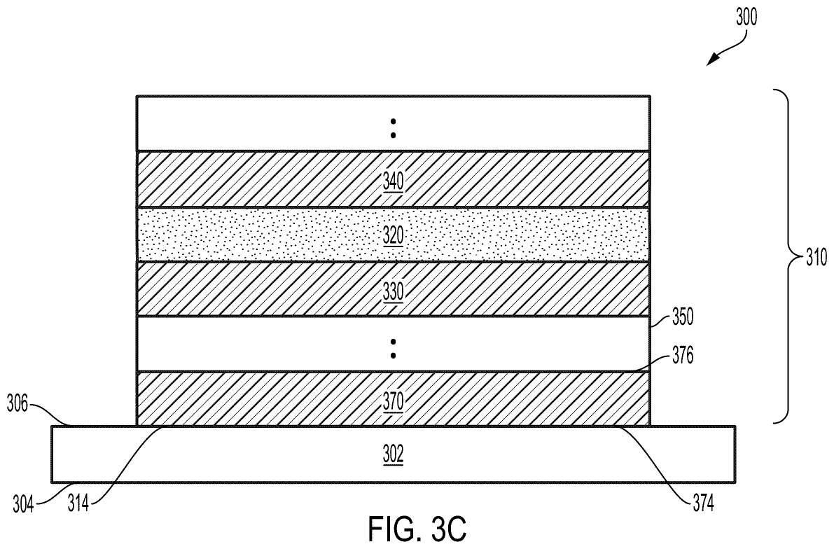

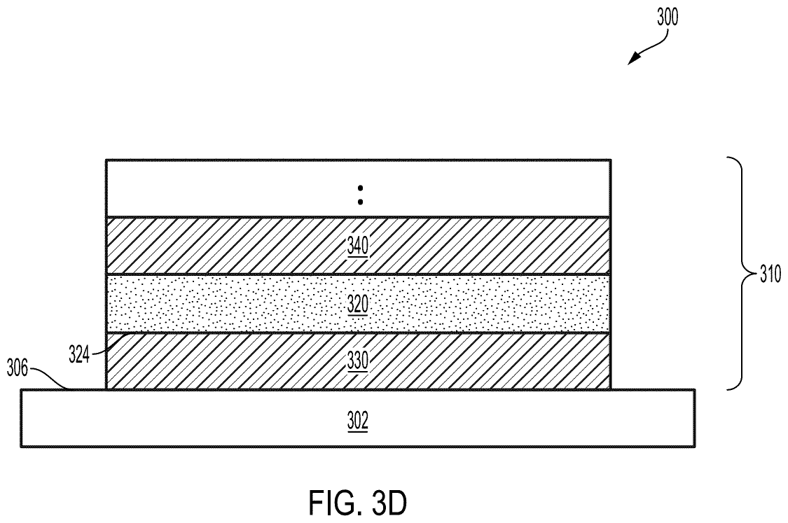

FIG. 3A schematically illustrates an optical element 300 according to some embodiments. In some embodiments, the optical element 300 may include a substrate 302 having a first major surface 304 and a second major surface 306 opposite the first major surface 304. The substrate 302 may have a thickness T defined by the distance between the first major surface 304 and the second major surface 306 of the substrate 302. In some embodiments, the thickness T of the substrate 302 may be greater than or equal to 0.5 mm and less than or equal to 50 mm, greater than or equal to 0.5 mm and less than or equal to 25 mm, greater than or equal to 0.5 mm and less than or equal to 10 mm, greater than or equal to 0.5 mm and less than or equal to 5 mm, greater than or equal to 0.5 mm and less than or equal to 1 mm, greater than or equal to 5 mm and less than or equal to 50 mm, greater than or equal to 5 mm and less than or equal to 25 mm, greater than or equal to 5 mm and less than or equal to 10 mm, greater than or equal to 10 mm and less than or equal to 50 mm, greater than or equal to 10 mm and less than or equal to 25 mm, or greater than or equal to 25 mm and less than or equal to 50 mm.

The substrate 302 may further include a lateral dimension L perpendicular to the thickness T of the substrate 302 and parallel to the first major surface 304 and/or the second major surface 306 of the substrate 302. In some embodiments, the lateral dimension L of the substrate 302 may be greater than or equal to 5 mm and less than or equal to 500 mm, greater than or equal to 5 mm and less than or equal to 250 mm, greater than or equal to 5 mm and less than or equal to 100 mm, greater than or equal to 5 mm and less than or equal to 50 mm, greater than or equal to 5 mm and less than or equal to 20 mm, greater than or equal to 20 mm and less than or equal to 500 mm, greater than or equal to 20 mm and less than or equal to 250 mm, greater than or equal to 20 mm and less than or equal to 100 mm, greater than or equal to 20 mm and less than or equal to 50 mm, greater than or equal to 50 mm and less than or equal to 500 mm, greater than or equal to 50 mm and less than or equal to 250 mm, greater than or equal to 50 mm and less than or equal to 100 mm, greater than or equal to 100 mm and less than or equal to 500 mm, greater than or equal to 100 mm and less than or equal to 250 mm, or greater than or equal to 250 mm and less than or equal to 500 mm.

In some embodiments, a ratio of the lateral dimension L of the substrate 302 to the thickness T of the substrate 302 may be greater than or equal to 0.1 and less than or equal to 15, greater than or equal to 0.5 and less than or equal to 10, greater than or equal to 1 and less than or equal to 5, or greater than or equal to 1 and less than or equal to 3.

In some embodiments, the substrate 302 may include a metallic material, a semiconductor material, or a dielectric material. In some embodiments, the substrate 302 may include at least one of aluminum or alloy thereof, sapphire, glass, oxides, chalcogenides (e.g., zinc sulfide, zinc selenide, etc.), fluorides, silicon, germanium, or any other suitable material, depending on the applications.

In some embodiments, the optical element 300 may further include a coating 310 atop the substrate 302 and having a first major surface 314 and a second major surface 316 opposite the first major surface 314. In some embodiments, the coating 310 may have a thickness defined as the distance between the first major surface 314 and the second major surface 316 of the coating 310. In some embodiments, the coating 310 may have a thickness greater than or equal to 80 nm and less than or equal to 15 μm, greater than or equal to 80 nm and less than or equal to 8 μm, greater than or equal to 80 nm and less than or equal to 1 μm, greater than or equal to 80 nm and less than or equal to 500 nm, greater than or equal to 80 nm and less than or equal to 200 nm, greater than or equal to 80 nm and less than or equal to 15 μm, greater than or equal to 80 nm and less than or equal to 8 μm, greater than or equal to 80 nm and less than or equal to 1 μm, greater than or equal to 80 nm and less than or equal to 500 nm, greater than or equal to 80 nm and less than or equal to 200 nm, greater than or equal to 200 nm and less than or equal to 15 μm, greater than or equal to 200 nm and less than or equal to 8 μm, greater than or equal to 200 nm and less than or equal to 1 μm, greater than or equal to 200 nm and less than or equal to 500 nm, greater than or equal to 500 nm and less than or equal to 15 μm, greater than or equal to 500 nm and less than or equal to 8 μm, greater than or equal to 500 nm and less than or equal to 1 μm, greater than or equal to 1 μm and less than or equal to 15 μm, greater than or equal to 1 μm and less than or equal to 8 μm, or greater than or equal to 8 μm and less than or equal to 15 μm.

In some embodiments, the coating 310 may be in direct contact with the substrate 302 such that the first major surface 314 of the coating 310 may be in direct contact with the second major surface 306 of the substrate 302. In some embodiments, the coating 310 may not cover the entire first major surface 304 of the substrate 302 and an area defined by the first major surface 314 of the coating 310 may be less than an area defined by the second major surface 306 of the substrate 302, such as shown in FIG. 3A. In some embodiments, an area defined by the first major surface 314 of the coating 310 may correspond to an area defined by the second major surface 306 of the substrate 302, and the coating 310 may cover the entire substrate 302, such as shown in FIG. 3B.

In some embodiments, the coating 310 may include a layer of Au 320 having a first major surface 324 and a second major surface 326 opposite the first major surface 324. In some embodiments, the layer of Au 320 may have a thickness defined as the distance between the first major surface 324 and the second major surface 326 of the layer of Au 320. In some embodiments, the layer of Au 320 may have a thickness greater than or equal to 10 nm and less than or equal to 300 nm, greater than or equal to 10 nm and less than or equal to 150 nm, greater than or equal to 10 nm and less than or equal to 100 nm, greater than or equal to 10 nm and less than or equal to 50 nm, greater than or equal to 10 nm and less than or equal to 25 nm, greater than or equal to 25 nm and less than or equal to 300 nm, greater than or equal to 25 nm and less than or equal to 150 nm, greater than or equal to 25 nm and less than or equal to 100 nm, greater than or equal to 25 nm and less than or equal to 50 nm, greater than or equal to 50 nm and less than or equal to 300 nm, greater than or equal to 50 nm and less than or equal to 150 nm, greater than or equal to 50 nm and less than or equal to 100 nm, greater than or equal to 100 nm and less than or equal to 300 nm, greater than or equal to 100 nm and less than or equal to 150 nm, or greater than or equal to 150 nm and less than or equal to 300 nm.

In some embodiments, the coating 310 may further include a first adhesion layer 330 and a second adhesion layer 340 on either side of the layer of Au 320. The first adhesion layer 330 may include a first major surface 334 and a second major surface 336 opposite the first major surface 334. The second adhesion layer 340 may include a first major surface 344 and a second major surface 346 opposite the first major surface 344. The second major surface 336 of the first adhesion layer 330 may directly contact and cover the entire first major surface 324 of the layer of Au 320. The first major surface 344 of the second adhesion layer 340 may directly contact and cover the entire second major surface 326 of the layer of Au 320.

Improved bonding between the layer of Au 320 and its neighboring layers may be formed via the first adhesion layer 330 and/or the second adhesion layer 340. For example, in some embodiments, the coating 310 may further include one or more layers 350 disposed between the substrate 302 and the layer of Au 320. Improved bonding between the layer of Au 320, specifically, the first major surface 324 of the layer of Au 320, and the one or more layers 350 may be formed via the first adhesion layer 330. In some embodiments, the coating 310 may further include one or more layers 360 disposed atop the layer of Au 320. Improved bonding between the layer of Au 320, specifically, the second major surface 326 of the layer of Au 320, and the one or more layers 360 may be formed via the second adhesion layer 340.

In some embodiments, the optical element 300 may further include a third adhesion layer 370 that may be disposed between the substrate 302 and the one or more layers 350 below the layer of Au 320, such as shown in FIG. 3C. The third adhesion layer 370 may include a first major surface 374 and a second major surface 376 opposite the first major surface 374. In some embodiments, the first major surface 374 of the third adhesion layer 370 may correspond to the first major surface 314 of the coating 310. The first major surface 374 of the third adhesion layer 370 may directly contact the second major surface 306 of the substrate 302. The second major surface 376 of the third adhesion layer 370 may directly contact the one or more layers 350. The third adhesion layer 370 may improve bonding between the substrate 302 and the one or more layers 350, thereby improving bonding between the coating stack 310 and the substrate 302 and preventing delamination of the coating 310 from the substrate 302.

In some embodiments, the layer of Au 320 and the substrate 302 may bond to each other by the adhesion layer 330 without any other layers disposed therebetween, such as shown in FIG. 3D. In these embodiments, the layer of Au 320 and the substrate 302 may be disposed on opposite sides of the adhesion layer 330, and the adhesion layer 330 may directly contact the first major surface 324 of the layer of Au 320 and directly contact the second major surface 306 of the substrate 302.

In some embodiments, a thickness of the first adhesion layer 330 may be defined by the distance between the first major surface 334 and the second major surface 336 of the first adhesion layer 330, a thickness of the second adhesion layer 340 may be defined by the distance between the first major surface 344 and the second major surface 346 of the second adhesion layer 340, and a thickness of the third adhesion layer 370 may be defined by the distance between the first major surface 374 and the second major surface 376 of the third adhesion layer 370. The first, second, and/or third adhesion layers 330, 340, 370 may each be sufficiently thick such that the continuity of the layer may be maintained to provide sufficient bonding strength. The first, second, and/or third adhesion layers 330, 340, 370 may not be too thick so as to minimize any negative effect on the optical performance of the optical element 300.

In some embodiments, the thickness of the adhesion layer described herein may be greater than or equal to 5 nm, greater than or equal to 10 nm, greater than or equal to 50 nm, greater than or equal to 100 nm, greater than or equal to 200 nm, greater than or equal to 400 nm, greater than or equal to 600 nm, greater than or equal to 800 nm, greater than or equal to 1000 nm, greater than or equal to 1200 nm, greater than or equal to 1400 nm, greater than or equal to 1600 nm, greater than or equal to 1800 nm, or greater than or equal to 1950 nm.

In some embodiments, the thickness of the adhesion layer described herein may be less than or equal to 2000 nm, less than or equal to 1900 nm, less than or equal to 1700 nm, less than or equal to 1500 nm, less than or equal to 1300 nm, less than or equal to 1100 nm, less than or equal to 900 nm, less than or equal to 700 nm, less than or equal to 500 nm, less than or equal to 300 nm, less than or equal to 100 nm, less than or equal to 70 nm, less than or equal to 30 nm, less than or equal to 15 nm, or less than or equal to 10 nm.

In some embodiments, the thickness of the adhesion layer described herein may be greater than or equal to 5 nm and less than or equal to 2000 nm—including all sub-ranges and values there-between, such as greater than or equal to 5 nm and less than or equal to 1000 nm, greater than or equal to 5 nm and less than or equal to 500 nm, greater than or equal to 5 nm and less than or equal to 100 nm, greater than or equal to 5 nm and less than or equal to 50 nm, greater than or equal to 5 nm and less than or equal to 10 nm, greater than or equal to 10 nm and less than or equal to 2000 nm, greater than or equal to 10 nm and less than or equal to 1000 nm, greater than or equal to 10 nm and less than or equal to 500 nm, greater than or equal to 10 nm and less than or equal to 100 nm, greater than or equal to 10 nm and less than or equal to 50 nm, greater than or equal to 50 nm and less than or equal to 2000 nm, greater than or equal to 50 nm and less than or equal to 1000 nm, greater than or equal to 50 nm and less than or equal to 500 nm, greater than or equal to 50 nm and less than or equal to 100 nm, greater than or equal to 100 nm and less than or equal to 2000 nm, greater than or equal to 100 nm and less than or equal to 1000 nm, greater than or equal to 100 nm and less than or equal to 500 nm, greater than or equal to 500 nm and less than or equal to 2000 nm, greater than or equal to 500 nm and less than or equal to 1000 nm, or greater than or equal to 1000 nm and less than or equal to 2000 nm.

In some embodiments, the adhesion layer described herein may include a high index material that may be optically transparent over the long wavelength infrared (LWIR) wavelengths from 7.5 microns to 13.5 microns. In some embodiments, the adhesion layer may have a refractive index greater than or equal to 1.8 at a wavelength range from 0.5 μm to 13.5 μm or even from 0.5 μm to 15 μm. In some embodiments, the adhesion layer may have an extinction coefficient less than or equal to 1E-6 at all wavelengths from 7.5 μm to 13.5 μm.

In some embodiments, the adhesion layer described herein may include a layer of zinc chalcogenide. In some embodiments, the layer of zinc chalcogenide may include a layer of ZnSe or a layer of ZnS. The layer of zinc chalcogenide may be formed by e-beam evaporation or thermal evaporation with or without ion assistance, which may provide freedom in hardware selection in a vacuum deposition chamber as compared to conventional Cr, Ni, Ti metal adhesion layers.

In addition to the process advantage, the adhesion layer described herein also provides excellent optical performance as compared to the conventional Cr, Ni, Ti metal adhesion layers. As discussed above, in mirror/reflector applications, the conventional Cr, Ni, Ti metal adhesion layers can degrade reflectance due to the high extinction coefficient (or k value) of the conventional Cr, Ni, Ti metal adhesion layers, which can cause significant absorption. To reduce absorption, the thickness of the adhesion layers shown in FIG. 2 above are typically about 2 nm. However, the adhesion layer can not be too thin so that the adhesion layer does not loss its continuity.

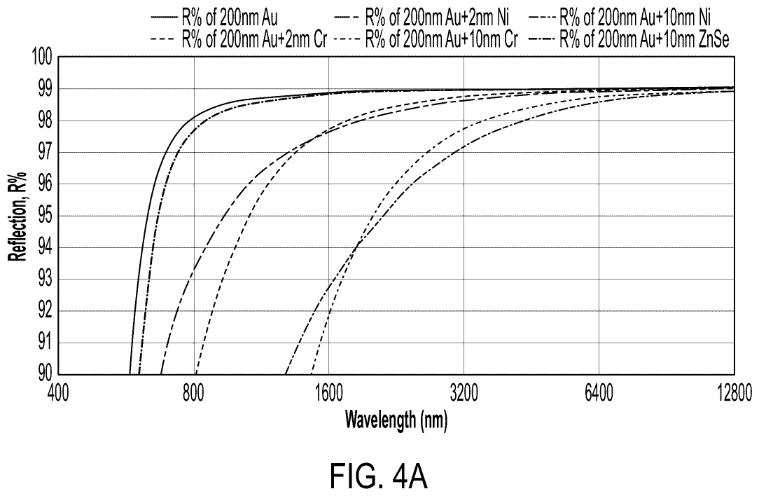

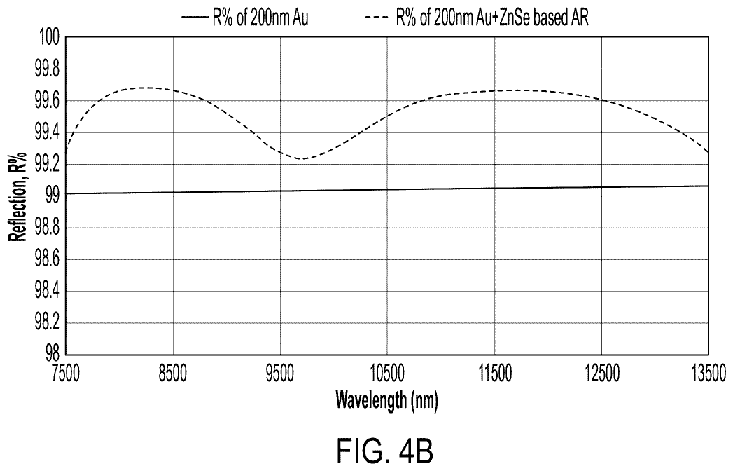

FIG. 4A shows the theoretical prediction of the surface reflectance (R %) for layers of Au with and without an adhesion layer covering the Au layer. As shown, even at 2 nm thickness, both the Cr adhesion layer and the Ni adhesion layer result in significant reflection reduction for wavelengths under 3 μm, and the respective reflectance remains lower than that of the Au layer without any adhesion layer through out the entire wavelength range the theoretical prediction was performed. Although some oxygen may be added to the Cr or Ni metal adhesion layers to control absorption, oxygen level cannot be close to stoichiometry so as not to lose the bonding effect. Thus, absorption is unavoidable for the metallic adhesion layers. In contrast, the reduction in reflectance of the Au layer covered with a zinc chalcogenide adhesion layer, such as a ZnSe adhesion layer, is minimal even at a thickness of 10 nm. In other words, the zinc chalcogenide adhesion layer has little to no absorption in a broad wavelength range from about 6 μm to about 14 μm, offering advantageous optical performance as compared to conventional Cr, Ni, Ti metal adhesion layers.

Furthermore, the inventors have found that the Au layer coated with a zinc chalcogenide adhesion layer may even have greater reflectance when compared to a Au layer without any coating. FIG. 4B shows the theoretical prediction of the surface reflectance (R %) of a Au layer coated with a zinc chalcogenide adhesion layer, such as a ZnSe adhesion layer, and the surface reflectance (R %) of a Au layer without any coating. As shown, the zinc chalcogenide adhesion layer may enhance the reflectance of the coated Au layer by an average of 0.5% for the wavelength range from about 7.5 μm to about 13.5 μm. In addition to the optical advantages, the adhesion layer described herein further demonstrates superior environmental and mechanical durability as will be discussed in more detail below.

As discussed above, in some embodiments, the optical element 300 may include one or more layers 350, 360 disposed on either side of the layer of Au 320 and bonded to the layer of Au 320 by the adhesion layers 330, 240 described herein. The one or more layers 350, 360 may include one or more metal, semiconductor, and/or dielectric layers. Depending on the application, the one or more layers 350, 360 may be configured to allow the layer of Au 320 to function as an outer reflector/mirror and/or an internal reflector/mirror as discussed below.

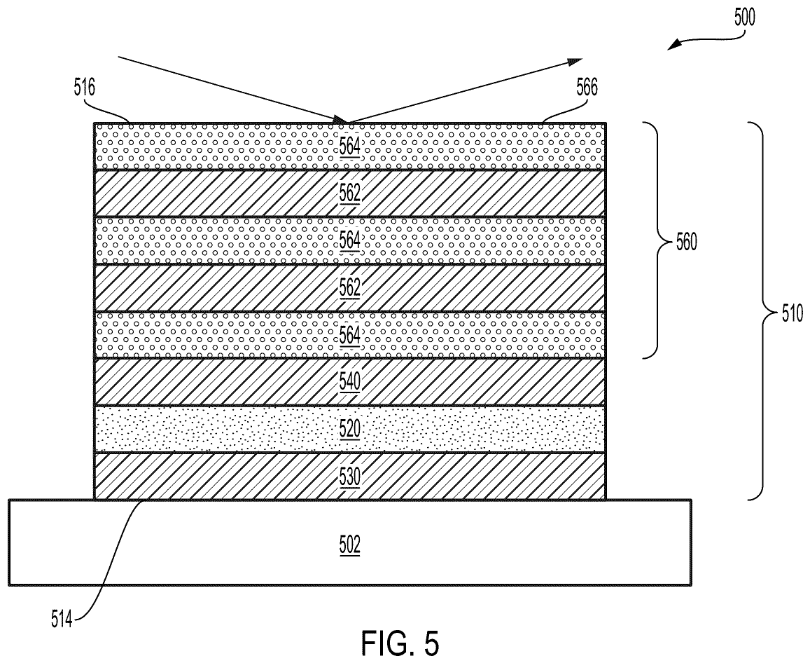

FIG. 5 schematically illustrates another optical element 500 according to some embodiments. The optical element 500 may employ an outer reflector/mirror design. Specifically, the optical element 500 may include a substrate 502 and a coating 510 disposed atop the substrate 502 and having a first major surface 514 and a second major surface 516 opposite the first major surface 514. The coating 510 may function as a gold mirror and may be configured such that the gold mirror operating as an outer reflector/mirror as discussed below.

Specifically, the coating 510 may include a layer of Au 520, a multi-layer stack 560 atop the layer of Au 520, and an adhesion layer 540 bonding the multi-layer stack 560 to the layer of Au 520. The multi-layer stack 560 may be disposed on the opposite side of the layer of Au 520 from the substrate 502. The multi-layer stack 560 may include alternating high index layers 562 and low index layers 564. Although certain number of high index layers 562 and low index layers 564 are shown in FIG. 5 for illustration purposes, it should be noted that the coating 510 may include any number of the alternating high index layers 562 and low index layers 564 depending on the application. In some embodiments, the high index layers 562 may include layers of chalcogenide glasses including ZnSe, ZnS, Ge, Si, TiO₂, Nb₂O₅, ZrO₂, HfO₂, Ta₂O₅, etc. In some embodiments, the low index layers 564 may include layers of YbF₃, MgF₂, CaF₂, AlF₃, GdF₃, BaF₂, LiF, SiO₂, Al₂O₃, etc. The multi-layer stack 560 may function to enhance reflection in the LWIR band of the gold mirror and may also provide environmental protection and scratch resistance to the gold mirror.

Similar to the adhesion layers 350, 360, 370 discussed above, the adhesion layer 540 may include a high index material that may be optically transparent over the wavelengths from 7.5 microns to 13.5 microns. Thus, in addition to improving the bonding between the layer of Au 520 and the multi-layer stack 560, the adhesion layer 540 and the multi-layer stack 560 may cooperate to promote reflection in the LWIR band. The adhesion layer 540 and the multi-layer stack 550 may collectively form a stack of high index layers and low index layers arranged in an alternating manner. In some embodiments, the adhesion layer 540 may include zinc chalcogenide, such as ZnSe, ZnS, etc.

During operation, light may be incident on an outer surface 566 of the multi-layer stack 560. Thus, the gold mirror of the optical element 500 may also be referred to as an outer reflector/mirror. In some embodiments, the outer surface 566 of the multi-layer stack 560 may also correspond to the second major surface 516 of the coating 510. It should be noted that although FIG. 5 shows light being reflected by the outer surface 566 of the multi-layer stack 560 for ease of illustration, one skilled in the art would appreciate that light may travel through the multi-layer stack 560 and the adhesion layer 540, and the reflection may be the combined effect of the layer of Au 520 and the various layers atop the layer of Au 520.

In some embodiments, the optical element 500 may further include an adhesion layer 530 disposed between the substrate 502 and the layer of Au 520. The adhesion layer 530 may directly contact the substrate 502 and directly contact the layer of Au 520 to establish strong bonding between the substrate 502 and the layer of Au 520, thereby enhancing the bonding strength of the gold mirror coating stack to the substrate 502 and preventing the delamination of the coating stack from the substrate 502. In some embodiments, the adhesion layer 530 may include zinc chalcogenide, such as ZnSe, ZnS, etc.

The coating 510 described herein may have an average reflectance of greater than or equal to 98%, greater than or equal to 98.1%, greater than or equal to 98.2%, greater than or equal to 98.3%, greater than or equal to 98.4%, greater than or equal to 98.5%, greater than or equal to 98.6%, greater than or equal to 98.7%, greater than or equal to 98.8%, greater than or equal to 98.9%, greater than or equal to 99%, greater than or equal to 99.1%, greater than or equal to 99.2%, greater than or equal to 99.3%, greater than or equal to 99.4%, greater than or equal to 99.5%, greater than or equal to 99.6%, greater than or equal to 99.7%, greater than or equal to 99.8%, or greater than or equal to 99.9%, for all wavelengths from 7.5 μm to 13.5 μm incident on the outer surface 566 at an angle of incidence that is greater than or equal to 5° and less than or equal to 55°, greater than or equal to 5° and less than or equal to 45°, greater than or equal to 5° and less than or equal to 35°, greater than or equal to 5° and less than or equal to 25°, greater than or equal to 5° and less than or equal to 15°, greater than or equal to 15° and less than or equal to 55°, greater than or equal to 15° and less than or equal to 45°, greater than or equal to 15° and less than or equal to 35°, greater than or equal to 15° and less than or equal to 25°, greater than or equal to 25° and less than or equal to 55°, greater than or equal to 25° and less than or equal to 45°, greater than or equal to 25° and less than or equal to 35°, greater than or equal to 35° and less than or equal to 55°, greater than or equal to 35° and less than or equal to 45°, or greater than or equal to 45° and less than or equal to 55°.

The coating 510 described herein may have an absorption of less than or equal to 1%, less than or equal to 0.9%, less than or equal to 0.8%, less than or equal to 0.7%, less than or equal to 0.6%, less than or equal to 0.5%, less than or equal to 0.4%, less than or equal to 0.3%, less than or equal to 0.2%, less than or equal to 0.1%, for all wavelengths from 7.5 μm to 13.5 μm incident on the outer surface 566 at an angle of incidence of about 10°.

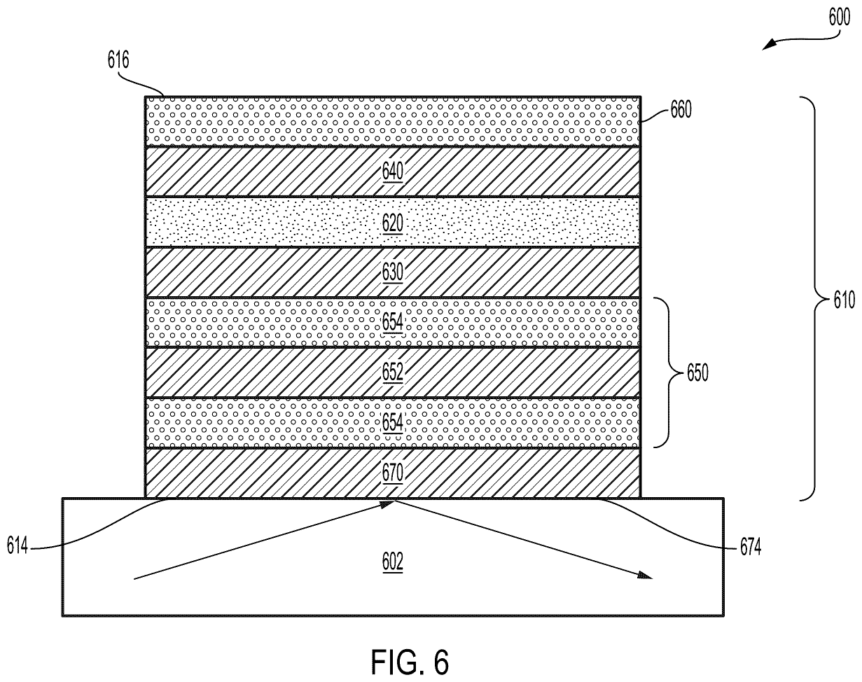

FIG. 6 schematically illustrates another optical element 600 according to some embodiments. The optical element 600 may employ an internal reflector/mirror design. Specifically, the optical element 600 may include a substrate 602 and a coating 610 disposed atop the substrate 602 and having a first major surface 614 and a second major surface 616 opposite the first major surface 614. The coating 610 may function as a gold mirror and the substrate 602 and the coating 610 may be configured such that the gold mirror operating as an internal reflector/mirror as discussed below.

In some embodiments, the substrate 602 may be include an IR substrate that may be substantially transparent and may have little or substantially no absorption in the 7.5 μm to 13.5 μm wavelength range. In some embodiments, the substrate 602 may include chalcogenide glass including zinc chalcogenide, such as ZnSe, ZnS, Ge, Si, MgF₂, CaF₂, plastics etc.

In some embodiments, the coating 610 may include a layer of Au 620, a multi-layer stack 650 disposed between the layer of Au 620 and the substrate 602, an adhesion layer 630 forming strong bonding between the layer of Au 620 and the multi-layer stack 650, and another adhesion layer 670 forming strong bonding between the multi-layer stack 650 and the substrate 602. The multi-layer stack 650 may include alternating high index layers 652 and low index layers 654. Although certain number of high index layers 652 and low index layers 654 are shown in FIG. 6 for illustration purposes, it should be noted that the coating 610 may include any number of the alternating high index layers 652 and low index layers 654 depending on the application. In some embodiments, the high index layers 652 may include layers of chalcogenide glasses including ZnSe, ZnS, Ge, Si, TiO₂, Nb₂O₅, ZrO₂, HfO₂, Ta₂O₅, etc. In some embodiments, the low index layers 654 may include layers of YbF₃, MgF₂, CaF₂, AlF₃, GdF₃, BaF₂, LiF, SiO₂, Al₂O₃ etc. The multi-layer stack 650 may function to enhance reflection in the LWIR band of the gold mirror.

Similar to the adhesion layers 350, 360, 370 discussed above, the adhesion layer 630 and/or the adhesion layer 670 may include a high index material that may be optically transparent over the wavelengths from 7.5 microns to 13.5 microns. Thus, in addition to improving the bonding strength, the adhesion layers 630, 670 and the multi-layer stack 650 may cooperate to promote reflection in the LWIR band. The adhesion layers 630, 670 and the multi-layer stack 650 may collectively form a stack of high index layers and low index layers arranged in an alternating manner. In some embodiments, the adhesion layer 630 and/or the adhesion layer 670 may include zinc chalcogenide, such as ZnSe, ZnS, etc.

During operation, light travelling in the substrate 602 may be incident on and reflected back to the substrate 602 by an internal surface 674 of the adhesion layer 670 covered by the substrate 602. Thus, the gold mirror of the optical element 600 may also be referred to as an internal reflector/mirror. In some embodiments, the internal surface 674 of the adhesion layer 670 may also correspond to the first major surface 614 of the coating 610. It should be noted that although FIG. 6 shows light being reflected by the surface 614, 674 immediately adjacent the substrate 602 for ease of illustration, one skilled in the art would appreciate that light may travel through the adhesion layer 670, the optical multi-layer stack 650, and/or the adhesion layer 630, and the reflection may be the combined effect of the layer of Au 620 and the various layers disposed between the substrate 602 and the layer of Au 620.

In some embodiments, the coating 610 may further include a protective layer 660 atop the layer of Au 620 and an adhesion layer 640 bonding the protective layer 660 to the layer of Au 620. Thus, the adhesion layer 640 and the protective layer 660 may cooperate to provide protection to the layer of Au 620 from damages and degradation. Although a single protective layer 660 is shown in FIG. 6 for illustration purposes, it should be noted that the coating 610 may include additional protective layers or other suitable layers depending on the application. In some embodiments, the protective layer 660 may include YbF₃, MgF₂, SiO₂, TiO₂, ZrO₂, Si₃N₄, diamond-like carbon (DLC), etc. In some embodiments, the adhesion layer 640 may include zinc chalcogenide, such as ZnSe, ZnS, etc.

The coating 610 described herein may have an average reflectance of greater than or equal to 98%, greater than or equal to 98.1%, greater than or equal to 98.2%, greater than or equal to 98.3%, greater than or equal to 98.4%, greater than or equal to 98.5%, greater than or equal to 98.6%, greater than or equal to 98.7%, greater than or equal to 98.8%, greater than or equal to 98.9%, greater than or equal to 99%, greater than or equal to 99.1%, greater than or equal to 99.2%, greater than or equal to 99.3%, greater than or equal to 99.4%, greater than or equal to 99.5%, greater than or equal to 99.6%, greater than or equal to 99.7%, greater than or equal to 99.8%, or greater than or equal to 99.9%, for all wavelengths from 7.5 μm to 13.5 μm incident on the internal surface 674 at an angle of incidence that is greater than or equal to 5° and less than or equal to 55°, greater than or equal to 5° and less than or equal to 45°, greater than or equal to 5° and less than or equal to 35°, greater than or equal to 5° and less than or equal to 25°, greater than or equal to 5° and less than or equal to 15°, greater than or equal to 15° and less than or equal to 55°, greater than or equal to 15° and less than or equal to 45°, greater than or equal to 15° and less than or equal to 35°, greater than or equal to 15° and less than or equal to 25°, greater than or equal to 25° and less than or equal to 55°, greater than or equal to 25° and less than or equal to 45°, greater than or equal to 25° and less than or equal to 35°, greater than or equal to 35° and less than or equal to 55°, greater than or equal to 35° and less than or equal to 45°, or greater than or equal to 45° and less than or equal to 55°.

The coating 610 described herein may have an absorption of less than or equal to 1%, less than or equal to 0.9%, less than or equal to 0.8%, less than or equal to 0.7%, less than or equal to 0.6%, less than or equal to 0.5%, less than or equal to 0.4%, less than or equal to 0.3%, less than or equal to 0.2%, less than or equal to 0.1%, for all wavelengths from 7.5 μm to 13.5 μm incident on the internal surface 674 at an angle of incidence of about 10°.

As will be discussed in more detail below, in addition to excellent optical performance, the various coatings and/or gold mirrors described herein further demonstrate superior environmental and mechanical durability, meeting or surpassing industry standards.

### EXAMPLES

The following examples describe various features and advantages provided by the disclosure, and are in no way intended to limit the invention and appended claims.

### Outer Reflector/Mirror

A first exemplary optical element, similar to that shown in FIG. 5, was prepared according to some embodiments. The first exemplary optical element includes an aluminum substrate and a gold mirror disposed atop the aluminum substrate. The gold mirror is configured to operate as an outer reflector/mirror, as discussed above with reference to FIG. 5. Specifically, the gold mirror includes a layer of Au and a multi-layer stack of alternating high index layers and low index layers disposed atop the layer of Au and on the opposite side of the layer of Au from the substrate. The high index layers in the first exemplary optical element include layers of ZnSe, and the low index layers in the first exemplary optical element include layers of YbF₃. The multi-layer stack includes a layer of ZnSe directly atop (or directly contacting) the layer of Au functioning as an adhesion layer and providing improved bonding between the layer of Au and the multi-layer stack. The first exemplary optical element further includes an adhesion layer of ZnSe disposed between the substrate and the layer of Au. This additional layer of ZnSe directly contacts the substrate and directly contacts the layer of Au to establish strong bonding between the gold mirror and the substrate.

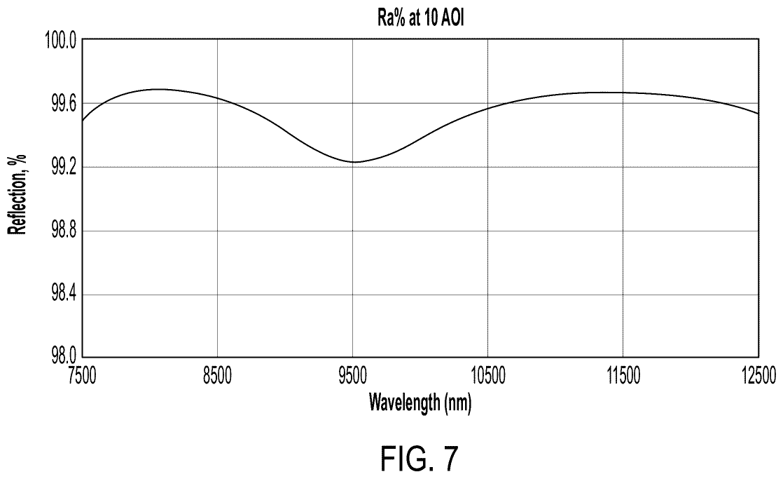

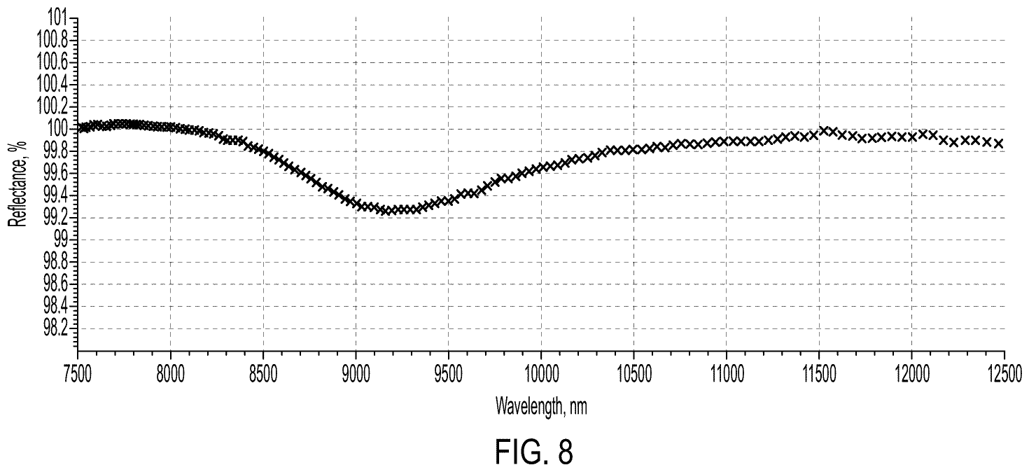

FIG. 7 shows the simulated reflectance of light incident on an outer surface of the gold mirror (as shown in FIG. 5) at an incident angle of about 10° for the wavelength band of 7.5 μm to 12.5 μm for the first exemplary optical element. FIG. 8 shows the measured reflectance of light incident on the outer surface of the gold mirror at an incident angle of about 10° for the wavelength band of 7.5 μm to 12.5 μm for the first exemplary optical element. As shown, the first exemplary optical element having an adhesion layer of ZnSe on either side of the layer of Au demonstrated superior optical performance, with the measured reflectance being very close to the prediction from simulated reflectance.

A second, third, and fourth exemplary optical elements were prepared according to some embodiments. The second, third, and fourth exemplary optical elements include a common gold mirror structure similar to that of the first exemplary optical element. The second optical element (Ex. 2) includes a substrate that includes an aluminum-containing coating formed by sputtering deposition followed by polishing and having the mirror coating deposited thereon. The third optical element (Ex. 3) includes a 6061 aluminum substrate. The fourth optical element (Ex. 4) includes a glass substrate, more specifically, a float glass substrate.

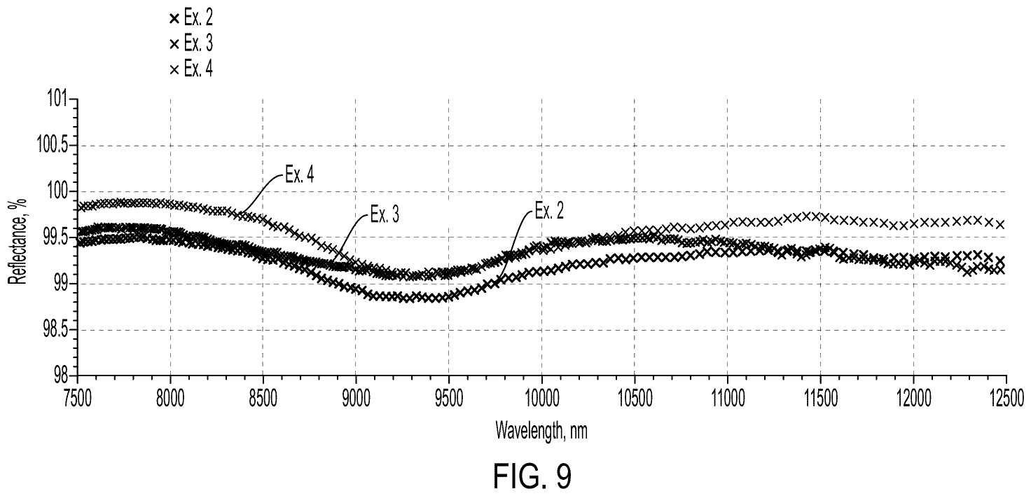

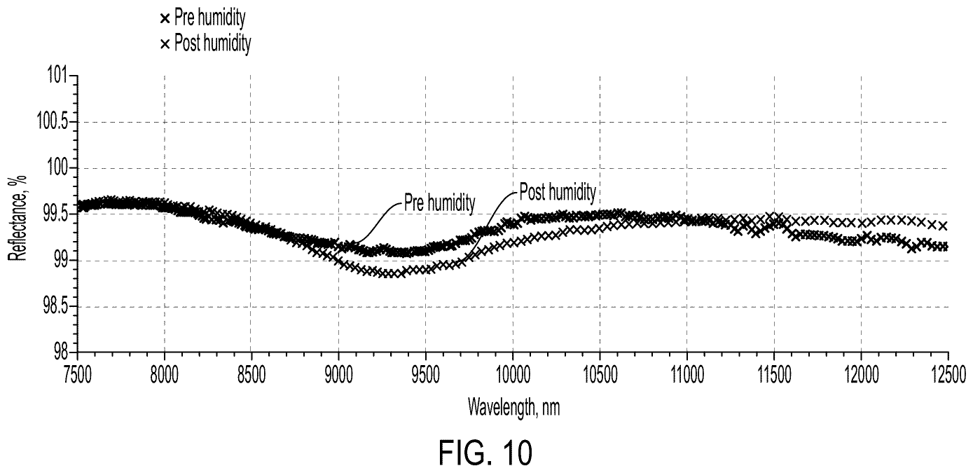

FIG. 9 shows the measured outer reflectance of the second, third, and fourth exemplary optical elements at an incident angle of about 10° for the wavelength band of 7.5 μm to 12.5 μm. As shown, each of the second, third, and fourth optical elements demonstrates excellent optical performance, with the fourth optical element having a greater reflectance which may be attributable to the better surface roughness of the float glass substrate. FIG. 10 further shows the outer reflectance of the third exemplary optical element before and after the humidity test conducted in accordance with MIL-C-48497A. As shown in FIG. 10, no significant change in the reflectance before and after the humidity test was observed, except for measurement related fluctuations.

As demonstrated in Table 1 below, all of the exemplary optical elements further exhibit superior environmental and mechanical durability. Specifically, tests based on MIL-C-48497A were conducted to confirm the durability of the adhesion layers. MIL-C-48497A requires the following: 1) adhesion test (tape test from edge to edge), 2) humidity test (24 hrs at 49° C., 98% RH), 3) abrasion test (50 rubs, cheesecloth, 9 psi), followed by repeating the adhesion test, 4) temperature test (5 cycles, −26° C., 71° C., 2 hr soak), and no observable change in reflection (R %) after tests 1) through 4). It is noted that when conducting the 4) temperature test, the exemplary optical elements were tested in a wider temperature range than that required by MIL-C-48497A. Specifically, liquid nitrogen was utilized to achieve temperatures ranging from 77 K (−196.15° C.) to 298 K (24.85° C.) for a temperature difference of 221 K (or 221° C.). After each test, the exemplary optical elements went through the cleaning process per MIL-C-48497A solubility and cleanability. The test results are summarized in Table 1. As shown, the exemplary optical elements passed all tests conducted, meeting or exceeding the specification of MIL-C-48497A.

TABLE 1

| | Ex. 2 | Ex. 3 | Ex. 4 |
|---|---|---|---|
| Substrate | w/ Al- | 6061 | Glass |
| | containing | aluminum | |
| | coating | | |
| Optical reflection, R % | Pass | Pass | Pass |
| Adhesion (tape test from edge) | Pass | Pass | Pass |
| Abrasion (50 rubs, cheesecloth, 9 psi) | NA | Pass | Pass |
| Temp (77 K, 298 K, three cycles) | Pass | Pass | Pass |
| Humidity (24 hrs at 49° C., 98% RH) | NA | Pass | Pass |
| Adhesion (tape test from edge) | Pass | Pass | Pass |
| Optical reflection, R % | Pass | Pass | Pass |

### Internal Reflector/Mirror

A fifth exemplary optical element, similar to that shown in FIG. 6, was prepared according to some embodiments. The fifth exemplary optical element employs an internal mirror design. Specifically, the fifth exemplary optical element includes an IR substrate, more specifically ZnSe substrate, and a gold mirror disposed atop the ZnSe substrate. The gold mirror includes a layer of Au, adhesion layers of ZnSe on either side of the layer of Au, an optical multi-layer stack of alternating high index layers (ZnSe) and low index layers (YbF₃), and a protective layer (YbF₃). The optical multi-layer stack is disposed between the layer of Au and the ZnSe substrate, and the protective multi-layer stack is disposed on the opposite sides of the layer of Au from the optical multi-layer stack. The fifth exemplary optical element further includes an additional adhesion layer of ZnSe between the substrate and the multi-layer stack that forms strong bonding between the substrate and the multi-layer stack and prevent mirror delamination.

In the fifth exemplary optical element, light travelling in the substrate is incident on the surface of the gold mirror that is covered by the substrate and is reflected by the gold mirror back into the substrate. Accordingly, the gold mirror of the fifth exemplary optical element is also referred to as an internal reflector/mirror.

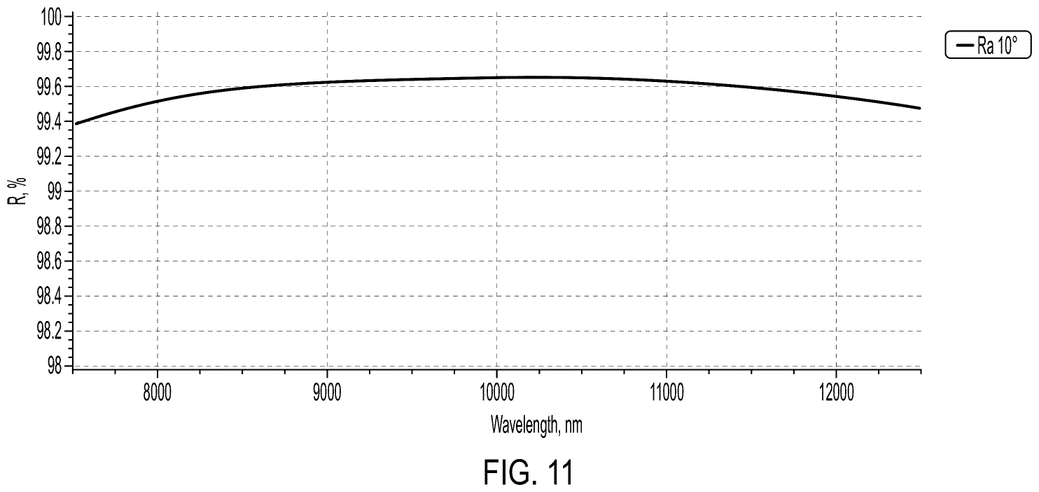

FIG. 11 shows the simulated internal reflectance of the fifth exemplary optical element. Based on the simulation, the gold mirror of the fifth exemplary optical element with the coatings containing ZnSe may achieve an even greater reflectance when compared to a layer of pure Au without any coating as shown in FIG. 4B.

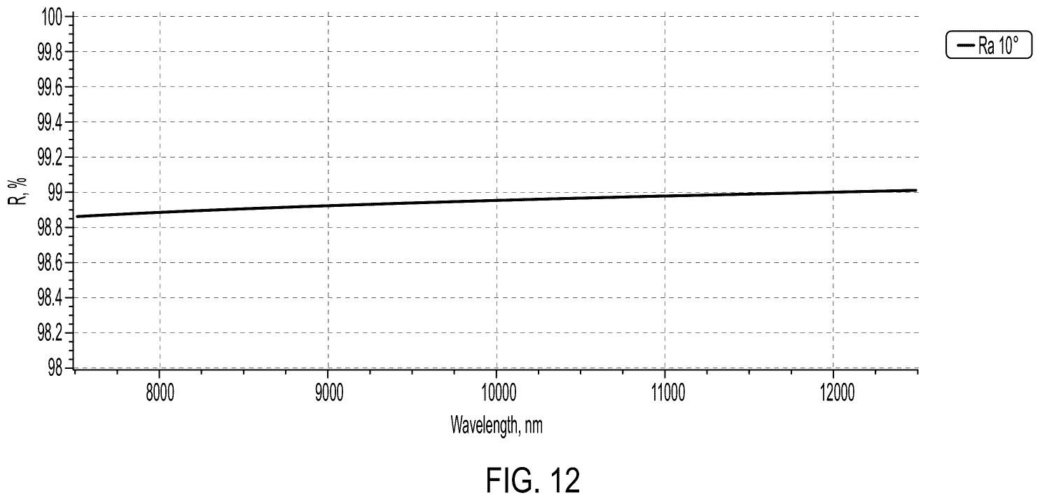

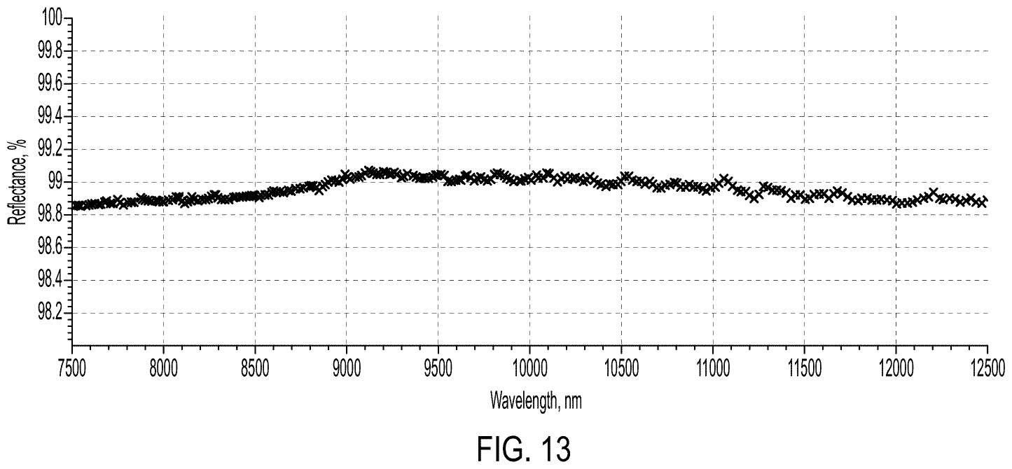

FIG. 12 shows the simulated air side reflectance of the fifth exemplary optical element, and FIG. 13 shows the measured air side reflectance of the fifth exemplary optical element. It should be noted that internal reflectance by the gold mirror of the fifth exemplary optical element cannot be measured directly. Typically, air side reflectance, i.e., reflectance of light traveling from air to the substrate and then reflected by the coating back into the air, is measured instead. The measured air side reflectance is then compared to the simulated air side reflectance. As shown by FIG. 12 and FIG. 13, the measured air side reflectance generally matches the simulated air side reflectance, indicating effective internal reflectance of the fifth exemplary optical element.

Table 2 summarizes the durability test results of the fifth exemplary optical element and a sixth exemplary optical element according to some embodiments. The fifth exemplary optical element and the sixth exemplary optical element include a common gold mirror structure, i.e., internal reflector/mirror design, but different substrate structures. The substrate of the fifth exemplary optical element includes a ZnSe disk that includes two opposite surfaces that are not parallel, and one of two surfaces is polished and has the mirror coating disposed thereon. The substrate of the sixth exemplary optical element includes a ZnSe disk that includes two opposite surfaces that are polished and parallel to each other, and the coating is disposed on one of the two surfaces. As shown, the fifth and sixth exemplary optical elements passed all tests conducted, meeting or exceeding the specification of MIL-C-48497A.

TABLE 2

| | Ex. 5 | Ex. 6 |
|---|---|---|
| Substrate | ZnSe wedge | ZnSe plano |
| Optical reflection, R % | Pass | Pass |
| Adhesion (tape test from edge) | Pass | Pass |
| Abrasion (50 rubs, cheesecloth, 9 psi) | Pass | Pass |
| Temp (77 K, 298 K, three cycles) | Pass | Pass |
| Humidity (24 hrs at 49° C., 98% RH) | Pass | Pass |

As shown, using an adhesion layer of zinc chalcogenide, strong bonding between a gold layer and its neighboring layers and/or various substrates can be formed, providing optical elements with superior environmental and mechanical durability and stability. Without intending to the bound by any particular theory, the inventors recognize that the zinc chalcogenide material may chemically bond to gold, aluminum or other metal, dielectrics, and/or semiconductors due to chemical miscibility. In general, zinc chalcogenide is a semiconductor material. For example, ZnSe, as a compound zinc chalcogenide semiconductor, has a wide bandgap of about 2.67 electron volts (eV) at room temperature. Bonding may occur through zinc chalcogenide bond to metal, semiconductor, and/or dielectric. Bonding may also occur through zinc bond to metal, semiconductor, and/or dielectric. For example, during deposition of ZnSe, Se vacancies may occur in the deposited ZnSe layer due to the relatively low vapor pressure of Se at typical growth temperatures, resulting in excess Zn atoms, which may have good chemical miscibility with many other elements, including gold, aluminum, etc.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

### Exemplary Claim Set

Exemplary Claim 1. An optical element, comprising: a substrate; and a coating; wherein the coating comprises: a first major surface, a second major surface opposite the first major surface, the first major surface of the coating is in direct contact with the substrate, a layer of zinc chalcogenide atop the substrate, and a layer of Au atop the layer of zinc chalcogenide.

Exemplary Claim 2. The optical element of Exemplary Claim 1, wherein the coating has an average reflectance of greater than or equal to 98%, or greater than or equal to 99%, for all wavelengths from 7.5 μm to 13.5 μm incident on the second major surface of the coating at an angle of incidence that is greater than or equal to 5° and less than or equal to 55°.

Exemplary Claim 3. The optical element of Exemplary Claim 2, wherein the coating further comprises a multi-layer stack of alternating high index layers and low index layers atop the layer of Au.

Exemplary Claim 4. The optical element of Exemplary Claim 1, wherein the coating has an average reflectance of greater than or equal to 98%, or greater than or equal to 99%, for all wavelengths from 7.5 μm to 13.5 μm incident on the first major surface of the coating at an angle of incidence that is greater than or equal to 5° and less than or equal to 55°.

Exemplary Claim 5. The optical element of Exemplary Claim 4, wherein the coating further comprises a multi-layer stack of alternating high index layers and low index layers, and wherein the layer of Au is disposed atop the multi-layer stack.

Exemplary Claim 6. The optical element of any of Exemplary Claim 4 to Exemplary Claim 5, wherein the substrate is substantially transparent for all wavelengths from 7.5 μm to 13.5 μm.

Exemplary Claim 7. The optical element of any of Exemplary Claim 1 to Exemplary Claim 6, wherein the layer of zinc chalcogenide comprises at least one of a layer of ZnSe or a layer of ZnS.

Exemplary Claim 8. The optical element of any one of Exemplary Claim 1 to Exemplary Claim 7, wherein the layer of Au is in direct contact with the layer of zinc chalcogenide.

Exemplary Claim 9. The optical element of any one of Exemplary Claim 1 to Exemplary Claim 8, wherein the layer of zinc chalcogenide is in direct contact with the substrate.

Exemplary Claim 10. The optical element of any one of Exemplary Claim 1 to Exemplary Claim 9, wherein the layer of Au has a thickness greater than or equal to 10 nm and less than or equal to 300 nm.

Exemplary Claim 11. The optical element of any one of Exemplary Claim 1 to Exemplary Claim 10, wherein the layer of zinc chalcogenide has a thickness greater than or equal to 5 nm and less than or equal to 2000 nm.

Exemplary Claim 12. The optical element of any one of Exemplary Claim 1 to Exemplary Claim 11, wherein the layer of zinc chalcogenide is a first layer of zinc chalcogenide, and wherein the coating further comprises: a second layer of zinc chalcogenide atop the layer of Au.

Exemplary Claim 13. The optical element of Exemplary Claim 12, wherein the second layer of zinc chalcogenide comprises at least one of a layer of ZnSe or a layer of ZnS.

Exemplary Claim 14. The optical element of any one of Exemplary Claim 12 to Exemplary Claim 13, wherein the second layer of zinc chalcogenide has a thickness greater than or equal to 5 nm and less than or equal to 2000 nm.

Exemplary Claim 15. The optical element of any one of Exemplary Claim 12 to Exemplary Claim 14, wherein the layer of Au is in direct contact with the second layer of zinc chalcogenide.

Exemplary Claim 16. The optical element of any one of Exemplary Claim 12 to Exemplary Claim 15, wherein at least one of the first layer of zinc chalcogenide or the second layer of zinc chalcogenide has an extinction coefficient less than or equal to 1E-6 at all wavelengths from 7.5 μm to 13.5 μm.

Exemplary Claim 17. The optical element of any one of Exemplary Claim 1 to Exemplary Claim 16, wherein the substrate comprising at least one of aluminum, aluminum alloy, sapphire, glass, oxides, chalcogenides, zinc sulfide, zinc selenide, fluorides, silicon, or germanium.

Exemplary Claim 18. The optical element of any one of Exemplary Claim 1 to Exemplary Claim 17, wherein a ratio of a lateral dimension of the substrate to a thickness of the substrate is greater than or equal to 0.1 and less than or equal to 15.

Exemplary Claim 19. An optical coating, comprising: a first layer of zinc chalcogenide; a layer of Au atop the first layer of zinc chalcogenide; and a second layer of zinc chalcogenide atop the layer of Au; wherein the coating has an average reflectance of greater than or equal to 98%, greater than or equal to 99% for all wavelengths from 7.5 μm to 13.5 μm incident on a major surface of the coating at an angle that is greater than or equal to 5° and less than or equal to 55°.

Exemplary Claim 20. The optical coating of Exemplary Claim 19, wherein at least one of the first layer of zinc chalcogenide or the second layer of zinc chalcogenide comprises a layer of ZnSe or a layer of ZnS.

Exemplary Claim 21. The optical coating of any one of Exemplary Claim 19 to Exemplary Claim 20, wherein the layer of Au is in direct contact with at least one of the first layer of zinc chalcogenide or the second layer of zinc chalcogenide.

Exemplary Claim 22. A method of making an optical element, comprising: forming a coating on a substrate; wherein forming the coating comprises: forming a layer of zinc chalcogenide atop the substrate, and forming a layer of Au atop the layer of zinc chalcogenide; wherein the coating comprises: a first major surface, a second major surface opposite the first major surface, and the first major surface of the coating is in direct contact with the substrate.

Exemplary Claim 23. The method of Exemplary Claim 22, wherein the coating has an average reflectance of greater than or equal to 98%, or greater than or equal to 99%, for all wavelengths from 7.5 μm to 13.5 μm incident on the second major surface of the coating at an angle of incidence that is greater than or equal to 5° and less than or equal to 55°.

Exemplary Claim 24. The method of Exemplary Claim 23, wherein the coating further comprises a multi-layer stack of alternating high index layers and low index layers atop the layer of Au.

Exemplary Claim 25. The method of Exemplary Claim 22, wherein the coating has an average reflectance of greater than or equal to 98%, or greater than or equal to 99%, for all wavelengths from 7.5 μm to 13.5 μm incident on the first major surface of the coating at an angle of incidence that is greater than or equal to 5° and less than or equal to 55°.

Exemplary Claim 26. The method of Exemplary Claim 25, wherein the coating further comprises a multi-layer stack of alternating high index layers and low index layers, and wherein the layer of Au is disposed atop the multi-layer stack.

Exemplary Claim 27. The method of any of Exemplary Claim 25 and Exemplary Claim 26, wherein the substrate is substantially transparent for all wavelengths from 7.5 μm to 13.5 μm. wherein the coating further comprises a multi-layer stack of alternating high index layers and low index layers, and wherein the layer of Au is disposed atop the multi-layer stack.

Exemplary Claim 28. The method of any one of Exemplary Claim 22 to Exemplary Claim 27, wherein the layer of zinc chalcogenide comprises at least one of a layer of ZnSe or a layer of ZnS.

Exemplary Claim 29. The method of any one of Exemplary Claim 22 to Exemplary Claim 28, wherein the layer of Au is in direct contact with the layer of zinc chalcogenide.

Exemplary Claim 30. The method of any one of Exemplary Claim 22 to Exemplary Claim 29, wherein the layer of zinc chalcogenide is in direct contact with the substrate.

Exemplary Claim 31. The method of any one of Exemplary Claim 22 to Exemplary Claim 30, wherein the layer of Au has a thickness greater than or equal to 10 nm and less than or equal to 300 nm.

Exemplary Claim 32. The method of any one of Exemplary Claim 22 to Exemplary Claim 31, wherein the layer of zinc chalcogenide has a thickness greater than or equal to 5 nm and less than or equal to 2000 nm.

Exemplary Claim 33. The method of any one of Exemplary Claim 22 to Exemplary Claim 32, wherein: the layer of zinc chalcogenide is a first layer of zinc chalcogenide; and forming the coating further comprises forming a second layer of zinc chalcogenide atop the layer of Au.

Exemplary Claim 34. The method of Exemplary Claim 33, wherein at least one of the first layer of zinc chalcogenide or the second layer of zinc chalcogenide is formed by thermal evaporation or e-beam evaporation.

Exemplary Claim 35. The method of any one of Exemplary Claim 33 to Exemplary Claim 34, wherein the second layer of zinc chalcogenide comprises at least one of a layer of ZnSe or a layer of ZnS.

Exemplary Claim 36. The method of any one of Exemplary Claim 33 to Exemplary Claim 35, wherein the second layer of zinc chalcogenide has a thickness greater than or equal to 5 nm and less than or equal to 2000 nm.

Exemplary Claim 37. The method of any one of Exemplary Claim 33 to Exemplary Claim 36, wherein the layer of Au is in direct contact with the second layer of zinc chalcogenide.

Exemplary Claim 38. The method of any one of Exemplary Claim 33 to Exemplary Claim 37, wherein at least one of the first layer of zinc chalcogenide or the second layer of zinc chalcogenide has an extinction coefficient less than or equal to 1E-6 at all wavelengths from 7.5 μm to 13.5 μm.

Exemplary Claim 39. The method of any one of Exemplary Claim 22 to Exemplary Claim 38, wherein the substrate comprising at least one of aluminum, aluminum alloy, sapphire, glass, oxides, chalcogenides, zinc sulfide, zinc selenide, fluorides, silicon, or germanium.

Exemplary Claim 40. A method of making an optical coating, comprising: forming a first layer of zinc chalcogenide; forming a layer of Au atop the first layer of zinc chalcogenide; and forming a second layer of zinc chalcogenide atop the layer of Au; wherein the coating has an average reflectance of greater than or equal to 98%, or greater than or equal to 99%, for all wavelengths from 7.5 μm to 13.5 μm incident on a major surface of the coating at an angle of incidence that is greater than or equal to 5° and less than or equal to 55°.

Exemplary Claim 41. The method of Exemplary Claim 40, wherein at least one of the first layer of zinc chalcogenide or the second layer of zinc chalcogenide comprises a layer of ZnSe or a layer of ZnS.

Exemplary Claim 42. The method of any one of Exemplary Claim 40 to Exemplary Claim 41, wherein the layer of Au is in direct contact with at least one of the first layer of zinc chalcogenide or the second layer of zinc chalcogenide.

What is claimed is:

1. An optical element, comprising:
a substrate; and
a coating, wherein the coating comprises:
a first major surface;
a second major surface opposite the first major surface;
the first major surface of the coating is in direct contact with the substrate;
a layer of zinc chalcogenide atop the substrate; and
a layer of Au atop the layer of zinc chalcogenide.

2. The optical element of claim 1, wherein the coating has an average reflectance of greater than or equal to 98%, or greater than or equal to 99%, for all wavelengths from 7.5 μm to 13.5 μm incident on the second major surface of the coating at an angle of incidence that is greater than or equal to 5° and less than or equal to 55°.

3. The optical element of claim 2, wherein the coating further comprises a multi-layer stack of alternating high index layers and low index layers atop the layer of Au.

4. The optical element of claim 1, wherein the coating has an average reflectance of greater than or equal to 98%, or greater than or equal to 99%, for all wavelengths from 7.5 μm to 13.5 μm incident on the first major surface of the coating at an angle of incidence that is greater than or equal to 5° and less than or equal to 55°.

5. The optical element of claim 4, wherein the coating further comprises a multi-layer stack of alternating high index layers and low index layers, and wherein the layer of Au is disposed atop the multi-layer stack.

6. The optical element of claim 4, wherein the substrate is substantially transparent for all wavelengths from 7.5 μm to 13.5 μm.

7. The optical element of claim 1, wherein the layer of zinc chalcogenide comprises at least one of a layer of ZnSe or a layer of ZnS.

8. The optical element of claim 1, wherein the layer of Au is in direct contact with the layer of zinc chalcogenide.

9. The optical element of claim 1, wherein the layer of zinc chalcogenide is in direct contact with the substrate.

10. The optical element of claim 1, wherein the layer of Au has a thickness greater than or equal to 10 nm and less than or equal to 300 nm.

11. The optical element of claim 1, wherein the layer of zinc chalcogenide has a thickness greater than or equal to 5 nm and less than or equal to 2000 nm.

12. The optical element of claim 1, wherein the layer of zinc chalcogenide is a first layer of zinc chalcogenide, and wherein the coating further comprises:
a second layer of zinc chalcogenide atop the layer of Au.

13. The optical element of claim 12, wherein the second layer of zinc chalcogenide comprises at least one of a layer of ZnSe or a layer of ZnS.

14. The optical element of claim 12, wherein the second layer of zinc chalcogenide has a thickness greater than or equal to 5 nm and less than or equal to 2000 nm.

15. The optical element of claim 12, wherein the layer of Au is in direct contact with the second layer of zinc chalcogenide.

16. The optical element of claim 12, wherein at least one of the first layer of zinc chalcogenide or the second layer of zinc chalcogenide has an extinction coefficient less than or equal to 1E-6 at all wavelengths from 7.5 μm to 13.5 μm.

17. The optical element of claim 1, wherein the substrate comprising at least one of aluminum, aluminum alloy, sapphire, glass, oxides, chalcogenides, zinc sulfide, zinc selenide, fluorides, silicon, or germanium.

18. An optical coating, comprising:
a first layer of zinc chalcogenide;
a layer of Au atop the first layer of zinc chalcogenide; and
a second layer of zinc chalcogenide atop the layer of Au;
wherein the coating has an average reflectance of greater than or equal to 98%, or greater than or equal to 99%, for all wavelengths from 7.5 μm to 13.5 μm incident on a major surface of the coating at an angle of incidence that is greater than or equal to 5° and less than or equal to 55°.

19. The optical coating of claim 18, wherein at least one of the first layer of zinc chalcogenide or the second layer of zinc chalcogenide comprises a layer of ZnSe or a layer of ZnS, and wherein the layer of Au is in direct contact with at least one of the first layer of zinc chalcogenide or the second layer of zinc chalcogenide.

20. A method of making an optical element, comprising:
forming a coating on a substrate, wherein forming the coating comprises:
forming a layer of zinc chalcogenide atop the substrate; and
forming a layer of Au atop the layer of zinc chalcogenide;
wherein the coating comprises:
a first major surface;
a second major surface opposite the first major surface; and
the first major surface of the coating is in direct contact with the substrate.
